(19) United States
(12) Patent Application Publication
(10) Pub. No.: US 2025/0203530 A1
(43) Pub. Date: Jun. 19, 2025

(54) METHOD AND ELECTRONIC DEVICE FOR TUNING AN ANTENNA

(71) Applicant: Samsung Electronics Co., Ltd., Suwon-si (KR)

(72) Inventors: Yue LING, Beijing (CN); Hua CHEN, Beijing (CN); Yingxin XIANG, Beijing (CN)

(21) Appl. No.: 18/806,115

(22) Filed: Aug. 15, 2024

Related U.S. Application Data
(63) Continuation of application No. PCT/KR2024/011524, filed on Aug. 5, 2024.

(30) Foreign Application Priority Data
Dec. 15, 2023 (CN) 202311735990.9

(51) Int. Cl. H04W 52/36; H04W 52/24

(52) U.S. Cl. CPC H04W 52/36; H04W 52/242

(57) ABSTRACT

An antenna tuning method, an antenna tuning device, an electronic apparatus, and/or a related storage medium may be provided. The antenna tuning method may include: determining a maximum and/or high radiated power of an antenna in response to detecting an abnormality of a transmitting state of the antenna; determining a headroom condition of the maximum and/or high radiated power for a current service type based on network parameters; determining a target receiving power based on the headroom condition; determining a tuning parameter corresponding to the target receiving power as a tuning parameter of the antenna.

This application is a continuation application of International Application No. PCT/KR2024/011524 designating the United States, filed on Aug. 5, 2024, in the Korean Intellectual Property Receiving Office and claiming priority to Chinese Patent Application No. 202311735990.9 filed on Dec. 15, 2023, the entire disclosures of which are all hereby incorporated herein by reference for all purposes.

### TECHNICAL FIELD

Certain example embodiments relate to a field of communication technology, and for example, to a method, an electronic device, and/or a non-transitory computer readable related storage medium for tuning an antenna.

### DESCRIPTION OF RELATED ART

With the development of the communication technology, a terminal including an antenna for transmitting and receiving a radio wave to perform signal transmission is widely used. The terminal usually needs to tune the antenna to a suitable state to ensure a good transmitting (TX) efficiency and receiving (RX) efficiency of the antenna. Usually, the terminal tunes the antenna to optimize the antenna efficiency by modifying a tuning parameter (tune code) of a tuner. However, the antenna tuned based on a factory-preset tuning parameter (e.g., a default tuning parameter) often fails to meet antenna efficiency requirements in different scenarios. For example, when the terminal is in a state such as hand-holding, the antenna based on the default tuning parameter cannot ensure an optimal radio frequency performance due to the change of parameters such as impedance. In order to improve the antenna efficiency, the tuning parameter of the antenna tuner is usually changed by changing a transmitting performance of the terminal antenna. However, a manner for adjusting the antenna by changing the transmitting performance usually meets requirements on an antenna receiving performance by losing a certain transmitting performance, but this manner cannot meet different antenna performance requirements for different services in different network environments.

Accordingly, there is a need for an antenna tuning method, an antenna tuning device, an electronic apparatus, and a storage medium capable of dynamically tuning an antenna to an optimal state taking into account antenna performance requirements for different services.

### SUMMARY

Certain example embodiments provide an antenna tuning method, an antenna tuning device, an electronic apparatus, and/or a related storage medium.

According to a an example embodiment, a method for tuning an antenna by an electronic device is provided. The method may include: determining a maximum radiated power of an antenna of the electronic device based on detecting an abnormality of a transmitting state of the antenna; determining a headroom condition of the maximum radiated power for a current service type based on network parameters; determining a target receiving power based on the headroom condition; and determining a tuning parameter of the antenna based on the target receiving power.

Alternatively or furthermore, the determining the headroom condition of the maximum radiated power for the current service type based on the network parameters may include: determining an uplink path loss and an expected transmitting power based on the network parameters; and determining the headroom condition of the maximum radiated power for the current service type based on the uplink path loss and the expected transmitting power, wherein the headroom condition may include a headroom adjustment step and a headroom adjustment range.

Alternatively or furthermore, the determining the headroom condition of the maximum radiated power for the current service type based on the uplink path loss and the expected transmitting power may include: determining the headroom adjustment step and a correction factor of the expected transmitting power for the current service type based on the uplink path loss; and determining the headroom adjustment range based on the expected transmitting power and the correction factor of the expected transmitting power.

Alternatively or furthermore, the determining the target receiving power based on the headroom condition may include: determining successively candidate receiving powers from among a plurality of receiving powers corresponding to a plurality of radiated powers within the headroom adjustment range based on the headroom adjustment step; and determining a candidate receiving power meeting a preset condition as the target receiving power.

Alternatively or furthermore, the preset condition may include that an uplink block error rate and a downlink block error rate within a predetermined time period meet requirements of block error rates corresponding to the current service type when the receiving power of the antenna is the candidate receiving power.

Alternatively or furthermore, the service type may include at least one of an uplink sensitive service, a downlink sensitive service, or an uplink-downlink both-sensitive service.

Alternatively or furthermore, the method may further include tuning the antenna based on the determined tuning parameter of the antenna.

According to an example embodiment, an electronic device for tuning an antenna is provided. The electronic device may include: memory storing instructions; and at least one processor coupled to the memory. The instructions, which when executed by the at least one processor, may cause the electronic device to perform operations. The operations may include determining a maximum radiated power of an antenna of the electronic device based on detecting an abnormality of a transmitting state of the antenna; determining a headroom condition of the maximum radiated power for a current service type based on network parameters; determining a target receiving power based on the headroom condition; and determining a tuning parameter of the antenna based on the target receiving power.

Alternatively or furthermore, determining the headroom condition of the maximum radiated power for the current service type based on the network may include: determining an uplink path loss and an expected transmitting power based on the network parameters; and determining the headroom condition of the maximum radiated power for the current service type based on the uplink path loss and the expected transmitting power, wherein the headroom condition may include a headroom adjustment step and a headroom adjustment range.

Alternatively or furthermore, determining the headroom condition of the maximum radiated power for the current service type based on the uplink path loss and the expected transmitting power may include: determining the headroom adjustment step and an correction factor of the expected transmitting power for the current service type based on the uplink path loss; and determining the headroom adjustment range based on the expected transmitting power and the correction factor of the expected transmitting power.

Alternatively or furthermore, determining the target receiving power based on the headroom condition may include: determining successively candidate receiving powers from among a plurality of receiving powers corresponding to a plurality of radiated powers within the headroom adjustment range based on the headroom adjustment step; and determining a candidate receiving power meeting a preset condition as the target receiving power.

Alternatively or furthermore, the preset condition may include that an uplink block error rate and a downlink block error rate within a predetermined time period meet requirements of block error rates corresponding to the current service type when the receiving power of the antenna is the candidate receiving power.

Alternatively or furthermore, the service type may include at least one of an uplink sensitive service, a downlink sensitive service, or an uplink-downlink both-sensitive service.

Alternatively or furthermore, the operations may further include tuning the antenna based on the determined tuning parameter of the antenna.

According to an example embodiment, a non-transitory computer-readable storage medium storing instructions is provided. The instructions which, when executed by at least one processor of an electronic device, may cause the electronic device to perform operations. The operations may include: determining a maximum radiated power of an antenna of the electronic device based on detecting an abnormality of a transmitting state of the antenna; determining a headroom condition of the maximum radiated power for a current service type based on network parameters; determining a target receiving power based on the headroom condition; and determining a tuning parameter of the antenna based on the target receiving power.

The antenna tuning method, the antenna tuning device, the electronic apparatus, and/or the storage medium according to various example embodiments may dynamically tune the antenna based on the service type and the network environment, which can adjust both the transmitting performance and the receiving performance of the antenna to an optimally balanced state as much as possible, and avoid or reduce the loss of the transmitting performance or the receiving performance due to the use of a fixed headroom for tuning. In addition, the antenna tuning method, the antenna tuning device, the electronic apparatus, and/or the storage medium according to various example embodiments can determine the optimal receiving power by using a block error rate (BLER), which can ensure the stability of the service in a case of ensuring the optimal antenna performance, thereby improving transmission quality.

It should be understood that the general description above and the detailed description in the following are only illustrative and explanatory, and cannot limit the present disclosure.

### BRIEF DESCRIPTION OF THE DRAWINGS

The foregoing and other aspects, features and advantages of certain example embodiments of the present disclosure will become more apparent by the following description in conjunction with the accompanying drawings, in which:

FIG. 1 is a diagram illustrating various power calculation points in an antenna structure according to an example embodiment;

FIG. 2 is a diagram illustrating a relationship between a transmitting power and a radiated power of an antenna according to an example embodiment;

FIG. 3 is a diagram illustrating an example processing for determining a tuning parameter based on a fixed headroom;

FIG. 4 is a flowchart illustrating an antenna tuning method according to an example embodiment;

FIG. 5 is a diagram illustrating an example of determining a target receiving power according to an example embodiment;

FIG. 6 is a block diagram illustrating an antenna tuning device according to an example embodiment; and

FIG. 7 is a block diagram illustrating an electronic apparatus according to an example embodiment.

### DETAILED DESCRIPTION

In order to enable those ordinary skilled in the art to better understand the technical solution of the present disclosure, technical solutions in embodiments of the present disclosure will be described clearly and completely in combination with the accompanying drawings.

The terms used herein are for the purpose of describing specific embodiments and are not intended to be limitation. As used herein, singular forms “a”, “the”, and “this” are also intended to include plural forms, unless the context clearly indicates otherwise. The terms “include/including” or “comprise/comprising” used in this specification, indicate the presence of the stated features, integers, steps, operations, elements, components, and/or combinations thereof, but do not preclude the presence or addition of one or more other features, integers, steps, operations, elements, components, and/or combinations thereof. The embodiments described in the following exemplary embodiments do not represent all embodiments consistent with the present disclosure. On the contrary, they are only examples of devices and methods consistent with some aspects of the present disclosure as detailed in the accompanying claims.

It should be noted that, “at least one of several items” appearing in the present disclosure all means that there are three kinds of juxtaposition situations: “any one of these items”, “a combination of any number of these items”, and “all of these items”. For example, “including at least one of A and B” includes the following three juxtaposition situations: (1) including A; (2) including B; (3) including A and B. As another example, “performing at least one of steps 1 and 2”, that is, means the following three juxtaposition situations: (1) performing step 1; (2) performing step 2; (3) performing steps 1 and 2.

Furthermore, terms “first”, “second” and so on in the claims, specification, and accompanying drawings of the present disclosure are used only to distinguish similar objects and need not be used to describe a particular order or sequence. It should be understood that the data so used may be interchangeable, where appropriate, so that the embodiments of the present disclosure described herein may be implemented in an order other than the order shown or described herein. In addition, the same reference numbers indicate the same or similar elements. The embodiments described in the following embodiments do not represent all embodiments consistent with the present disclosure. Rather, they are only examples of embodiments consistent with some aspects of the present disclosure.

In order to facilitate an understanding of a concept of the present disclosure, some of the terms of the present disclosure are firstly explained before the present disclosure is described in detail.

In the present disclosure, a “terminal” may be an apparatus that transmits and receives a signal using an antenna, which may also be referred to as a user equipment (UE), a terminal apparatus, a mobile station (MS), a mobile terminal (MT), a subscriber station (SS), a remote terminal, a wireless terminal, or a reception point, and the like. The terminal according to the present disclosure may be an apparatus having a wireless communication function, for example, but not limited to examples of terminals, which may include, but are not limited to, at least one of a smart phone, a tablet personal computer (PC), a mobile phone, a video phone, an e-book reader, a desktop PC, a laptop computer, a netbook computer, a workstation, a server, a personal digital assistant (PDA), a portable multimedia player (PMP), a MP3 Player, a mobile medical apparatus, a camera, a wearable apparatus, an onboard apparatus, etc.

Furthermore, in the present disclosure, “network equipment” may be any apparatus that provides wireless access to a network for a terminal, which may also be referred to as a network node, a base station (BS), a core network node, or a network server and so on. Examples of the network equipment according to the present disclosure may include, but are not limited to, a transmit point (TP), a transmit-receive point (TRP), an enhanced (or “evolved”) base station (eNodeB or eNB), a 5G base station (gNB), a macro cell, a femtocell, a wireless fidelity (WiFi), an access point (AP), or other apparatuses having a wireless capability.

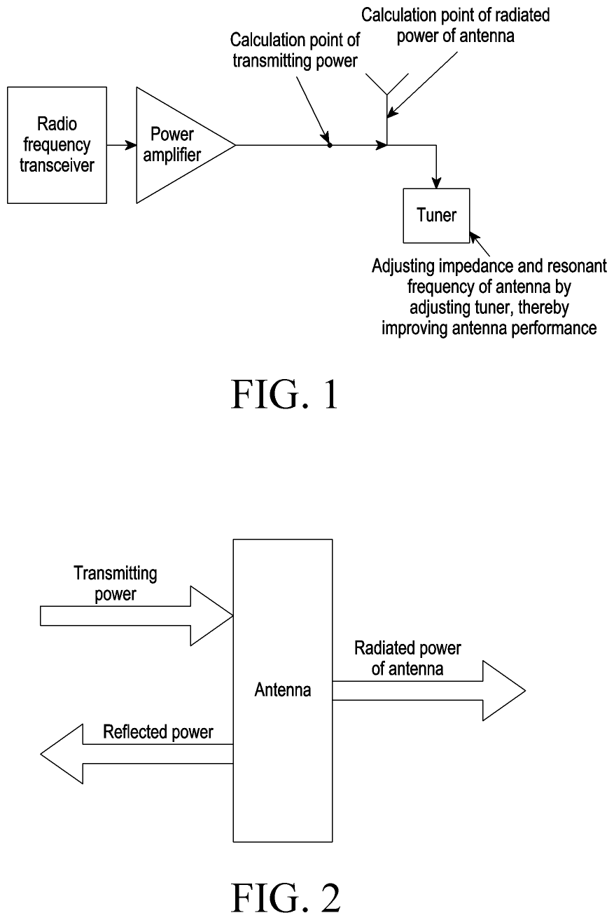

In the present disclosure, an antenna performance may also be understood as “antenna efficiency”, herein, the antenna efficiency or antenna performance is described with a “radiated power” and a “receiving power” of the antenna. The larger the radiated power and the receiving power are, the higher the antenna efficiency or the better the antenna performance is. Herein, the maximum and/or high radiated power may be denoted as TxBe and the maximum and/or high receiving power may be denoted as RxBe. In the following, a definition of the “radiated power” will be described in detail with reference to FIGS. 1 and 2.

FIG. 1 is a diagram illustrating various power calculation points in an antenna structure according to an example embodiment. FIG. 2 is a diagram illustrating a relationship between a transmitting power and a radiated power of an antenna.

Referring to FIG. 1, the antenna structure may include a radio frequency transceiver (WTR), a power amplifier (PA), and a tuner. The radio frequency transceiver is used to transmit or receive signals at different frequencies. The power amplifier is used to amplify the signals. According to the example embodiment, the transmitted signal amplified by the power amplifier may be used to calculate or determine the transmitting power of the antenna, e.g., the transmitting power may be calculated at an output of the power amplifier in FIG. 1. Herein, a “transmitting power” may also be referred to as a “radio frequency power” or “radio frequency transmitting power”, wherein the maximum transmitting power may be the maximum and/or a high transmitting power determined by the radio frequency link of the terminal.

According to the example embodiment, the radiated power used to characterize the antenna efficiency is often less than the transmitting power due to a line loss such as an adapter and a feeder line connecting the antenna. Referring to FIG. 2, a transmitting power (Pin) determined at a pre-stage circuit (e.g., a power amplifier) becomes a radiated power (Pout) of the antenna when it passes through the antenna for transmission, wherein the radiated power of the antenna is a difference between the transmitting power and a reflected power (Prev) of the antenna, that is, Pout=Pin−Prev.

According to the example embodiment, an antenna efficiency conversion rate η is determined by using the transmitting power and the reflected power of the antenna. Specifically, the antenna efficiency conversion rate η is determined by using the following equation (1).

$$η = ( Pin - Prev ) / Pin \qquad ( 1 )$$

Wherein Pin of the antenna is a pre-known or pre-determined value and Prev is a value determined as a matter of experience or dynamically measured in real time. The application of the antenna efficiency conversion rate η will be described in detail in the following embodiments.

Although FIG. 1 illustrates the antenna structure according to the example embodiment, the antenna structure is intended only to illustrate the differences between the various power calculation points, and the antenna of the present disclosure is not limited thereto.

In order to avoid obscuring the present disclosure with unnecessary details, a specific processing for receiving and transmitting signals of the antenna structure is not described in detail herein.

Referring back to FIG. 2, according to the example embodiment, different tuning parameters (tune codes) correspond to different impedances and/or resonance frequencies of the tuner, and the impedance and/or resonance frequency of the tuner may be adjusted to change a state of the tuner by using the tuning parameter, thereby realizing a purpose of improving the antenna performance.

As mentioned above, in order to adjust the antenna performance, the tuner of the antenna is adjusted using tuning parameter to improve the antenna efficiency. Antenna efficiency is closely related to the frequency of the wireless signal, and different frequencies require different tuning parameter. For frequency division duplex (FDD) mode, a terminal with the same physical antenna for transmission and reception cannot tune the antenna's transmission performance and receiving performance to be optimal at the same time because the transmission frequency is different from the reception frequency.

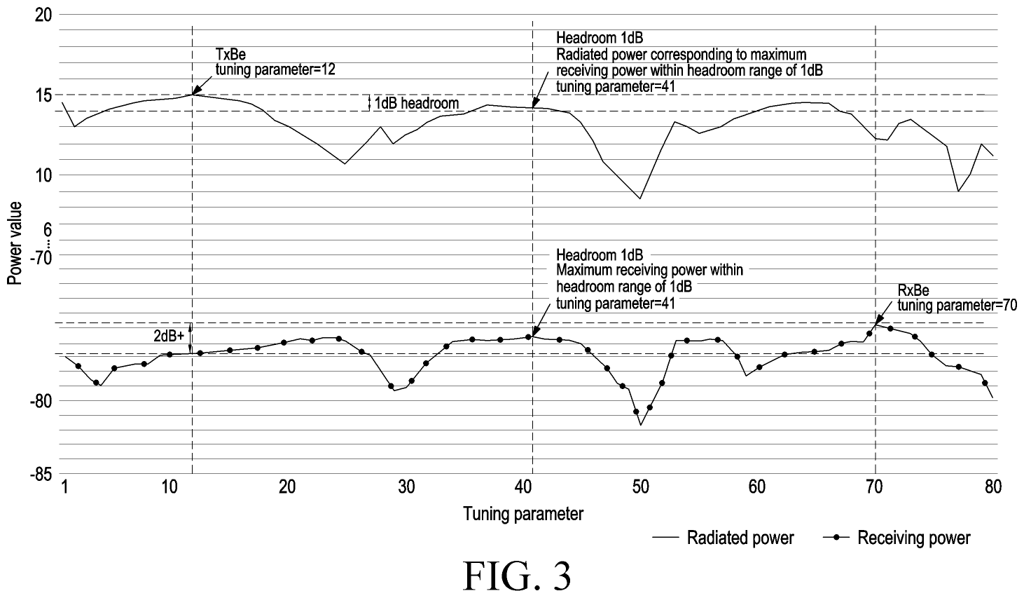

In order to give consideration to both the transmitting and receiving efficiency of the antenna, a fixed allowable headroom (or simply “headroom”) for adjusting the radiated power corresponding to the transmitting efficiency may be preset. The allowable headroom of the radiated power may indicate a difference between the maximum radiated power TxBe and the minimum allowable radiated power. In other words, the radiated power within the range defined by the allowable headroom of the maximum radiated power TxBe meets transmitting performance requirements of the antenna. Within the range of the radiated power determined based on the allowable headroom, an optimal receiving power is determined, and a tuning parameter corresponding to the determined optimal receiving power is determined as a tuning parameter for tuning the antenna. An example of determining the tuning parameter based on the fixed headroom is described in detail below with reference to FIG. 3.

FIG. 3 is a diagram illustrating a processing for determining a tuning parameter based on a fixed headroom. In FIG. 3, radiated powers and receiving powers corresponding to different tuning parameters are illustrated in a long term evolution (LTE) B14 band as an example, assuming a preset fixed headroom of 1 dB. A vertical axis of the graph in FIG. 3 represents the radiated power (in dB), and a horizontal axis represents the tuning parameter (tune code).

Referring to FIG. 3, it can be seen that the antenna has the maximum radiated power TxBe when the tuning parameter is about 12, and the antenna has an optimal transmitting performance at this time. However, a difference between a receiving power at the tuning parameter of 12 and the maximum receiving power (RxBe) among all the receiving powers of the antenna (in FIG. 3, a tuning parameter corresponding to RxBe is 70) is up to 2 dB+. In this case, the optimal receiving power may be found in a section defined by a radiated power in the range where the radiated power loses the fixed headroom (e.g., 1 dB). As can be seen in FIG. 3, within the section defined by the radiated power in a headroom range of a 1 dB with respect to TxBe, a corresponding maximum receiving power is at the tuning parameter of 41. Therefore, the tuning parameter of the tuner for tuning the antenna is determined to be 41.

In this case, the terminal loses a certain amount of transmitting performance or transmitting efficiency (e.g., a performance loss of less than or equal to 1 dB of the radiated power) to meet requirements on the receiving performance or receive efficiency, but the determined tuning parameter may not be the optimal tuning scheme for the antenna, and the transmitting performance and receiving performance corresponding to the determined tuning parameter may not achieve the optimal equilibrium state.

In addition, due to various unpredictable changes in an environment at which the terminal is located, the preset fixed headroom cannot be appropriately adjusted according to various environments, and in this case, dynamic adjustment of the antenna performance cannot be implemented either.

For example, due to the complexity and variability of the network environment, different services of the terminal have different requirements on the transmitting performance or receiving performance in different network environments. For example, for a transmitting sensitive service (e.g., a random access procedure, a data upload processing, etc.), the terminal may be offline directly perhaps due to the degradation of the transmitting performance adjusted by using the fixed headroom. For example, for a receiving sensitive service (e.g., online video playback, data download, etc.), a reference signal receiving power (RSRP) or signal to noise ratio (SNR) of a received signal may be too poor perhaps due to the receiving performance not being optimal, so that the terminal is unable to perform demodulation and resulting in data stall. Therefore, in a case of the limited transmitting performance, adjusting the tuning parameter via the fixed headroom cannot meet the performance requirements of the terminal on different services in different network environments.

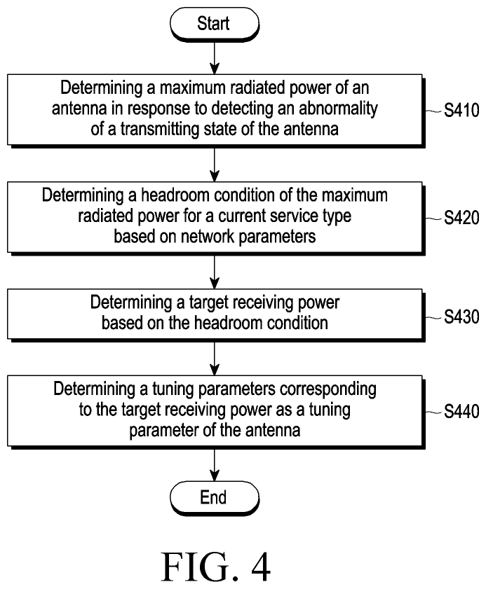

Considering at least the above problems, an antenna tuning method, an antenna tuning device, an electronic apparatus, and a storage medium for dynamically determining a tuning parameter are proposed. The embodiments according to the present disclosure may dynamically adjust a headroom condition to determine a suitable tuning parameter based on a service type of a terminal and network parameters (in particular, an uplink path loss (ULPL)). The embodiments according to the present disclosure may also determine a suitable tuning parameter within a suitable headroom range in conjunction with a block error rate (BLER), to tune the antenna to the optimal efficiency. The antenna tuning method, the antenna tuning device, the electronic apparatus, and the storage medium according to the embodiments of the present disclosure will be described below with reference to FIGS. 4 to 7.

FIG. 4 is a flowchart illustrating an antenna tuning method according to an example embodiment.

Referring to FIG. 4, at step S410, a maximum radiated power TxBe of an antenna is determined in response to detecting an abnormality of a transmitting state of the antenna. Specifically, when the transmitting state of the antenna is changed to abnormal, a current transmitting power and a current receiving power may not be able to meet antenna performance requirements, and in this case, the antenna needs to be tuned in a timely manner.

According to the example embodiment, whether the transmitting state of the antenna is abnormal or not may be determined by using a standing wave ratio of the antenna. The standing wave ratio may be formed by a reflected wave which is generated due to the fact that an incident wave energy transferred to an input of the antenna is not fully absorbed (radiated). According to the example embodiment, the transmitting state may be determined to be abnormal when the standing wave ratio is greater than or equal to a threshold S. Here, a value of the threshold S may be set according to actual needs or experience, and may typically be 1.5. For example, but not limited to, when the terminal is in a hand-holding state, the TX of the antenna may be abnormal due to a change in impedance and other factors.

According to the example embodiment, the radiated power and receiving power of the antenna at different tuning parameters may be predetermined, or a correspondence between different tuning parameters and different radiated and receiving powers of the antenna may be predetermined. For example, but not limited to, the graph including the correspondence between the tuning parameters and the radiated and receiving powers as illustrated in FIG. 3 may be predetermined. According to the example embodiment, although only correspondence in a form of the graph is shown in the present disclosure, the present disclosure is not limited to, and the correspondence between the tuning parameters and the radiated and receiving powers may be predetermined using any suitable form.

When the transmitting state is determined to be abnormal, the maximum radiated power TxBe with the optimal transmitting performance may be directly determined or found, and after the maximum radiated power TxBe is determined, a dynamic headroom with respect to the maximum radiated power TxBe may be determined, and in the example embodiment, the headroom is defined by a headroom condition.

At step S420, the headroom condition of the maximum radiated power TxBe for a current service type is determined based on network parameters. Specifically, the headroom condition may be used to determine radiated powers within a dynamic headroom range meeting the predetermined radiated power, thereby determining a corresponding tuning parameter section in which an expected receiving power may be determined.

According to the example embodiment, the service type may include at least one of uplink sensitive (e.g., type) service, a downlink sensitive (e.g., type) service, and an uplink-downlink both-sensitive (e.g., type) service. Due to the diversification of the services of the terminal, a transmitting sensitive (e.g., type) service (e.g., a random access procedure, a data upload processing, etc.) in the uplink sensitive service needs the antenna to prioritize the transmitting performance, the receiving sensitive (e.g., type) service (e.g., online video playback, data download, etc.) in the downlink sensitive service needs to prioritize the receiving performance, and the uplink-downlink both-sensitive (e.g., type) service (e.g., a call service, an online live broadcasting service, etc.) needs to simultaneously meet both the transmitting and receiving performances.

Specifically, for the uplink sensitive service, a key process of signal transmission or most of time is to transmit data, whether the data transmitted by the terminal can reach the network equipment will directly affect normal operations of the service, therefore, it is necessary for the terminal to prioritize to ensure the transmitting performance in the process of tuning the antenna. For the downlink sensitive service, a main demand for signal transmission is to receive data, less demand for data transmitting, a normal reception and demodulation of the data through the network is a key to ensure the normal operations of the service, therefore, it is necessary to prioritize the receiving performance of the terminal in the process of tuning the antenna. For the uplink-downlink both-sensitive service, the signal transmission needs to interact with the network equipment frequently, and the normal transmission and reception of data will directly affect the normal operations of the service, therefore, it is necessary for the terminal to ensure both the transmitting performance and the receiving performance in the process of tuning the antenna. The embodiments of the present disclosure tune the antenna based on the service type of the terminal, taking into account the different requirements of different service types on the transmitting performance and the receiving performance.

In addition to considering the service type of the terminal, the present disclosure also considers an effect of the network environment on the antenna. A channel quality in the network environment may directly affect an efficiency of signal transmitting and receiving. According to the example embodiment, an uplink path loss (ULPL), which is used to indicate a quality of an uplink channel for the environment at which the terminal is currently located, may be determined based on the network parameters, and the antenna may be tuned based on the ULPL.

Specifically, the network equipment carries power-related parameters of a base station (e.g., a reference signal power, a preamble receiving target power, etc.) in a broadcast message, and carries power control-related parameters (e.g., a correction factor of an uplink path loss, etc.) in a radio resource control (RRC) reconfiguration message or a RRC Setup message. A downlink path loss (DLPL) at the current environment may be calculated based on the received network parameters, and the uplink path loss may be determined based on the DLPL.

According to the example embodiment, the downlink path loss may be determined by subtracting a reference signal receiving power (RSRP) of the terminal from the reference signal power of the base station.

According to the example embodiment, the uplink path loss may be determined by multiplying the downlink path loss with the correction factor of the uplink path loss.

In order to avoid obscuring the present disclosure with unnecessary details, the detailed details regarding the calculation of the downlink path loss and the uplink path loss are not described, the specific reference may be made to 3GPP Technical Specification 38.213.

According to the example embodiment, a value section of the uplink path loss may be divided, as a matter of experience, into a plurality of sections such as 3 sections which representing different uplink channel quality areas, respectively. For example, but without limitation, the current environment may be determined as an uplink weak signal area when 95 dB<ULPL<110 dB, the current environment may be identified as an uplink medium signal area when 80 dB<ULP≤95 dB, and the current environment may be identified as an uplink strong signal area when ULPL≤80 dB. The present disclosure does not limit the specific details regarding the division of the value section of the uplink path loss.

In addition, according to the example embodiment, the expected transmitting power TxEx as described above may be determined based on the network parameters. Specifically, as described above, the uplink path loss and the downlink path loss may be determined based on the network parameters, and further, the expected transmitting power TxEx may be determined based on the uplink path loss and the downlink path loss as well as other network parameters. For example, TxEx may be determined based on the maximum transmitting power, a network power control parameter set, and the uplink path loss, wherein the network power control parameter set is related to factors such as network uplink resource scheduling and uplink power control configuration. For example, a calculated transmitting power may be determined by adding the network power control parameter set to the uplink path loss, and the expected transmitting power TxEx is the maximum transmitting power when the calculated transmitting power≥the maximum transmitting power (e.g., the maximum transmitting power determined by the radio frequency link of the terminal, as described above). The expected transmitting power TxEx is the calculated transmitting power when the calculated transmitting power<the maximum transmitting power.

Here, in order to avoid obscuring the present disclosure with unnecessary details, the detailed details regarding the calculation of the expected transmitting power TxEx are not described, the specific reference may be made to 3GPP Technical Specification 38.213.

The present disclosure proposes to consider both the type of service and the network environment (for example, the uplink path loss, the expected transmitting power TxEx, etc.) simultaneously to tune the antenna, and according to the example embodiment, the headroom condition of the maximum radiated power TxBe for the current service type is determined based on the uplink path loss and the expected transmitting power TxEx, wherein the headroom condition may include a headroom adjustment step (in dB) and a headroom adjustment range (in dB).

According to the embodiment, the headroom adjustment step may indicate a step for adjusting the headroom successively, and the larger a value of the headroom adjustment step is, the larger an amount of loss of the radiated power is, therefore, the value of the headroom adjustment step is critical for tuning the antenna.

According to the embodiment, the headroom adjustment range may be associated with the headroom adjustment step and the number of times of headroom adjustments, and the radiated power within the headroom adjustment range does not exceed a range defined by a maximum allowable headroom (the maximum allowable headroom=the headroom adjustment step*maximum number of times of headroom adjustments).

The processing for determining the headroom adjustment step and the headroom adjustment range are described in detail below, respectively.

According to the example embodiment, the determining the headroom condition of the maximum radiated power TxBe for the current service type based on the uplink path loss and the expected transmitting power TxEx may include: determining the headroom adjustment step and an correction factor of the expected transmitting power TxEx_offset for the current service type based on the uplink loss. That is, the determination of the headroom adjusting step is determined by combining different service types and different uplink channel qualities. Here, the details of operations of determining the correction factor of the expected transmitting power TxEx_offset will be described in detail later, and the details of determining the headroom adjustment step will be described firstly.

For example, since the uplink sensitive service has a high requirement on the transmitting performance of the terminal, the transmitting performance needs to be as close to the optimum state as possible, so the value of the headroom adjustment step in the headroom condition of the radiated power should be as small as possible. If the headroom adjustment step is taken to be too large, it can result in a significant loss of the transmitting performance after tuning, so that the transmit data cannot reach the network equipment or the terminal fails to access the network.

As another example, since the downlink sensitive service should try to ensure the receiving performance, the terminal may tolerate a greater loss of the transmitting performance in a case of ensuring that the terminal is not out-of-step with the network, the value of the headroom adjustment step may be set larger.

As another example, the uplink-downlink both-sensitive service should equalize the transmitting performance requirement with the receiving performance requirement, and thus, the headroom adjustment step may be set to a value in the middle of the two aforementioned headroom adjustment steps.

In addition, for example, for the same service type, the radiated powers required by the terminal are different in different uplink channel quality areas. Usually, in order to ensure that the uplink data can reach the network equipment normally, the larger the uplink path loss is, the larger the radiated power required by the terminal is, and the corresponding value of the headroom adjustment step should be dynamically adjusted to be larger. For example, when in the uplink weak signal area, signal attenuation (or channel loss) is very large, in order to ensure that the uplink data can reach the network equipment normally, the loss of the transmitting performance should be as small as possible and thus, the value of the headroom adjustment step should be as small as possible. As another example, when in the uplink strong signal area, the signal attenuation (or channel loss) is small, and the value of the headroom adjustment step may be set to be larger. For example, when in the medium signal area, the signal attenuation (or channel loss) is moderate, and the value of the headroom adjustment step may be set to a value in the middle of the two aforementioned values.

According to the example embodiment, a power ratio P for tuning a power corresponding to the headroom adjustment step may be determined, and the power ratio may be related to the radiated power after tuning versus the radiated power before tuning, for example, a relationship between the power ratio P (in dB) and the power man be determined by the following equation (2).

$$P = 10 * log ( P 1 / P 0 ) \qquad ( 2 )$$

Wherein P1 may represent the radiated power after tuning and P0 may represent the radiated power before tuning.

For example, when the radiated power after tuning is twice the radiated power before tuning (a gain amplitude of 100%), the power ratio is P=10*log(2)=3 dB.

According to the example embodiment, specific values of headroom adjustment steps corresponding to different service types and the network parameters may be set in advance as a matter of experience. This will be described in detail below.

In the related art, transmitting antenna diversity and an uplink data retransmission mechanism both provide gains in uplink transmission. The transmitting antenna diversity is transfer of the same data in a frequency domain by adding the transmitting antenna, which theoretically results in a gain of about 100% (e.g., 3 dB) per antenna. However, the uplink data retransmission mechanism, which retransmits data when the uplink data is not reachable, is diversity in a time domain, which also theoretically results in gain of 100% (e.g., 3 dB). After tuning the antenna according to the headroom, the transmitting performance is decreased and therefore, the gain resulting from the diversity cannot be fully utilized. In order to ensure the transmitting performance, it is expected that the antenna maintains the gain more than 60% after tuning. Therefore, according to the example embodiment, a debuff in the transmitting performance after each tuning using the headroom adjustment step should not exceed 40%, and accordingly, P(dB)=10*log(P1/P0)=10*log(0.6)=−2.2 dB, and thus the maximum value of the headroom adjustment step should not exceed 2.2 dB, but this value is only exemplary, and the present disclosure is not limited to this.

In addition, the downlink sensitive service allows for a larger amount of loss for transmitting compared to the uplink sensitive service, and in the example embodiment, the difference between the maximum headroom adjustment steps of uplink and downlink is set to 1 dB (a power debuff of about 20%).

Based on the above principle of setting the headroom adjustment step (e.g., not exceeding 2.2 dB), in the example embodiment, the maximum value of the headroom adjustment step is set to 2 dB, and the values of the headroom adjustment steps for different uplink channel quality areas under the same service type are differentiated by a difference of 0.5 dB.

The correspondences between the set headroom adjustment steps, the service types, and the uplink path losses are shown exemplarily below by Table 1.

TABLE 1

| | Channel quality | | | | |
|---|---|---|---|---|---|
| | area divided | Headroom | | | |
| Service type | based on ULPL | adjustment step | | TxEx_offset | |
| Uplink | Uplink strong | 1 | dB | 1 | dB |
| sensitive | signal area | | | | |
| service | Uplink medium | 0.5 | dB | 1 | dB |
| | signal area | | | | |
| | Uplink weak | 0.2 | dB | 1 | dB |
| | signal area | | | | |
| Downlink | Uplink strong | 2 | dB | 2 | dB |
| sensitive | signal area | | | | |
| service | Uplink medium | 1.5 | dB | 2 | dB |
| | signal area | | | | |
| | Uplink weak | 1 | dB | 2 | dB |
| | signal area | | | | |
| Uplink- | Uplink strong | 1.5 | dB | 1.5 | dB |
| downlink both- | signal area | | | | |
| sensitive | Uplink medium | 1 | dB | 1.5 | dB |
| service | signal area | | | | |
| | Uplink weak | 0.5 | dB | 1.5 | dB |
| | signal area | | | | |

In Table 1, based on the above design logic and dB conversion principle of adjusting the headroom adjustment step with the service type and the uplink path loss, for example, for the uplink sensitive service, the value of the headroom adjustment step at the uplink strong/medium/weak signal area is set to 1 dB/0.5 dB/0.2 dB, respectively, and the corresponding P is set to −1 dB/0.5 dB/−0.2 dB, respectively, and the corresponding radiated power (or transmitting performance) has a decreasing amplitude of about 20%/10%/5%, respectively. Similarly, for the downlink sensitive service, the value of the headroom adjustment step at the uplink strong/medium/weak signal area is set to 2 dB/1.5 dB/1 dB, the corresponding transmitting performance has a decreasing amplitude of about 35%/30%/20%, respectively. Similarly, for the uplink-downlink both-sensitive service, the value of the headroom adjustment step at the uplink strong/medium/weak signal area is set to 1.5 dB/1 dB/0.5 dB, respectively, the corresponding transmitting performance has a decreasing amplitude of about 30%/20%/10%.

Although the values of the headroom adjustment steps for different service types and uplink path losses are shown in Table 1, the above parameters are only exemplary reference values, and the present disclosure is not limited thereto, and the values of the uplink path losses and the headroom adjustment steps may be adjusted according to specific implementation scenarios (e.g., a performance of the terminal radio frequency device, a specific scenario requirement, etc.).

In addition, the correction factors of the expected transmitting power TxEx_offset corresponding to different service types and the channel quality areas are shown in Table 1 and will be described now.

In the present disclosure, when tuning the antenna, considering the complexity of the environment and variety of the service types, the expected transmitting power TxEx determined as described above may deviate from the transmitting power actually required by the terminal, and there may be a situation in which a suitable antenna efficiency is still not obtained after determining the tuning parameter based on the headroom and adjusting the antenna, and for this reason, the present disclosure also proposes to adjust the expected transmitting power TxEx using the correction factor of the expected transmitting power (also referred to as a “power offset”) TxEx_offset. The correction factor of the expected transmitting power TxEx_offset of the expected transmitting power TxEx for the current service type may be determined based on the uplink path loss, as described above.

According to the example embodiment, TxEx_offset may be used to represent a compensation factor for guaranteeing the antenna performance (in particular, the transmitting performance), and different TxEx_offsets are set for different service types in consideration of different requirements on the transmitting performance when performing services in different services types, wherein the TxEx_offset of the uplink sensitive service<TxEx_offset of the uplink-downlink both-sensitive service<TxEx_offset of the downlink sensitive service.

In addition, as described above, due to the limitation of TxEx, it is still possible that the antenna efficiency may not be suitable after the tuning is completed. In the present disclosure, a probability of obtaining the suitable antenna efficiency will be increased by performing an additional tuning. Therefore, the principle of the value of TxEx_offset also relies on compensating for one headroom adjustment step (e.g., adding an additional round of tuning processing based on the headroom adjustment step).

According to the embodiment, the TxEx_offset for the current service type may be determined based on the uplink path loss. Alternatively, the TxEx_offset may also be determined only based on the service type. Table 1 exemplarily shows the correspondences between the TxEx_offsets and the service types. In Table 1, only a case where the values of TxEx_offsets are dependent on the service types and the headroom adjustment steps is shown, wherein the TxEx_offset of the uplink sensitive service is set to the same value as the headroom adjustment step at the uplink strong signal area. In Table 1, the value of TxEx_offset of uplink sensitive service/downlink sensitive service/uplink-downlink both-sensitive service is set to 1 dB/2 dB/1.5 dB, respectively. Although the values of the TxEx_offsets of different service types are shown in Table 1, the parameters described above are only exemplary reference values, the present disclosure is not limited thereto, and the value of TxEx_offset may be adjusted according to specific implementation scenarios (e.g., a performance of the terminal radio frequency device, a specific scenario requirement, etc.).

Furthermore, in the present disclosure, the processing of dynamically adjusting the headroom is proposed, and therefore, in addition to determining the headroom adjustment step included in the headroom condition, it is also necessary to dynamically determine the headroom adjustment range included in the headroom condition.

According to the embodiment, the headroom adjustment range is determined based on the expected transmitting power TxEx and the correction factor of the expected transmitting power TxEx_offset.

According to the embodiment, the headroom adjustment range may be understood as a power value section of the radiated power dynamically determined based on the headroom adjustment step, wherein a difference between a maximum value and a minimum value of the power value section is equal to the headroom adjustment step. As described above, since the headroom adjustment range may be associated with the headroom adjustment step and the number of times of headroom adjustments t, and it is defined by the maximum allowable headroom, firstly, a limitation condition on the headroom adjustment range may be determined indirectly by determining the maximum number of times of headroom adjustments associated with the maximum allowable headroom, and then, the corresponding headroom range is determined.

A relationship between the headroom adjustment step (step), the maximum number of times of headroom adjustments n, TxEx and TxEx_offset may be defined by the following equation (3):

$$TxBe - step * n \geq TxEx * η - TxEx\_offet \qquad ( 3 )$$

Wherein, TxBe may be the maximum radiated power, step may represent the headroom adjustment step, n may represent the maximum number of times of headroom adjustments, TxEx may be the expected transmitting power, η may be the antenna efficiency conversion rate, and TxEx_offset may be the correction factor of the expected transmitting power.

In the equation (3), when the difference between the maximum radiated power TxBe and a certain radiated power is greater than step*n, this radiated power may not meet the requirement of the transmitting performance, and therefore, the tuning parameter corresponding to this radiated power is not allowed.

By way of the equation (3), step*n may represent the maximum allowable headroom, and the maximum value of n which is a positive integer may be obtained by dividing a result of TxBe-TxEx*η+TxEx_offset by the headroom adjustment step step. Accordingly, the minimum value of the headroom adjustment range must be greater than or equal to TxEx*η−TxEx_offset.

In the following, n is the maximum number of times to perform the processing of determining a candidate receiving power successively based on the headroom adjustment step. After determining the limitation condition on the number of times of headroom adjustments t associated with the headroom adjustment range, the headroom adjustment range may be determined.

According to the embodiment, the headroom adjustment range is related to the headroom adjustment step and the number of times of headroom adjustments, and for ease of description, the radiated power within the headroom adjustment range may be referred to as a candidate radiated power. According to the embodiment, a difference between TxBe and a candidate radiated power by the t-th headroom adjustment is between a product of the headroom adjustment step and (t−1) and a product of the headroom adjustment step and t, wherein t is a positive integer greater than or equal to 1 and less than or equal to n.

For example, the headroom condition may include, but is not limited to, at the t-th headroom adjustment, the difference between the maximum radiated power TxBe and the candidate radiated power Txₜ within the headroom adjustment range is less than or equal to a product of the headroom adjustment step and t and greater than a product of the headroom adjustment step and (t−1), and the candidate radiated power Txₜ in the headroom condition of the t-th headroom adjustment may be expressed as the following equation (4):

$$TxBe - t * step \leq {Tx}_{t} < TxBe - ( t - 1 ) * step \qquad ( 4 )$$

Wherein TxBe is the maximum radiated power, step is the headroom adjustment step, and t is a positive integer greater than or equal to 1 and less than or equal to n.

In other words, the headroom adjustment range may be a range of power values corresponding to the t-th headroom adjustment step step defined based on the number of times of headroom adjustments t.

According to the embodiment, at first headroom adjustment, the candidate radiant power Txₜ may include TxBe. That is, at first determination of the headroom adjustment range, TxBe may be included in the radiated powers meeting the headroom condition.

As such, the headroom adjustment step and the correction factor of the expected transmitting power TxEx_offset for the current service type may be determined based on the uplink path loss, and the headroom adjustment range may be determined based on the expected transmitting power TxEx and the correction factor of the expected transmitting power TxEx_offset, thereby determining the headroom condition of the maximum radiated power TxBe for the current service type.

Referring back to FIG. 4, at step S430, a target receiving power is determined based on the headroom condition. Specifically, based on the headroom condition, a plurality of radiated powers meeting the headroom condition may be determined, the plurality of determined radiated powers may correspond to a plurality of tuning parameters (or tuning parameter sections) and corresponding plurality of receiving powers, and the target receiving power (e.g., the expected receiving power after tuning the tuning parameter) may be determined from among the plurality of receiving powers.

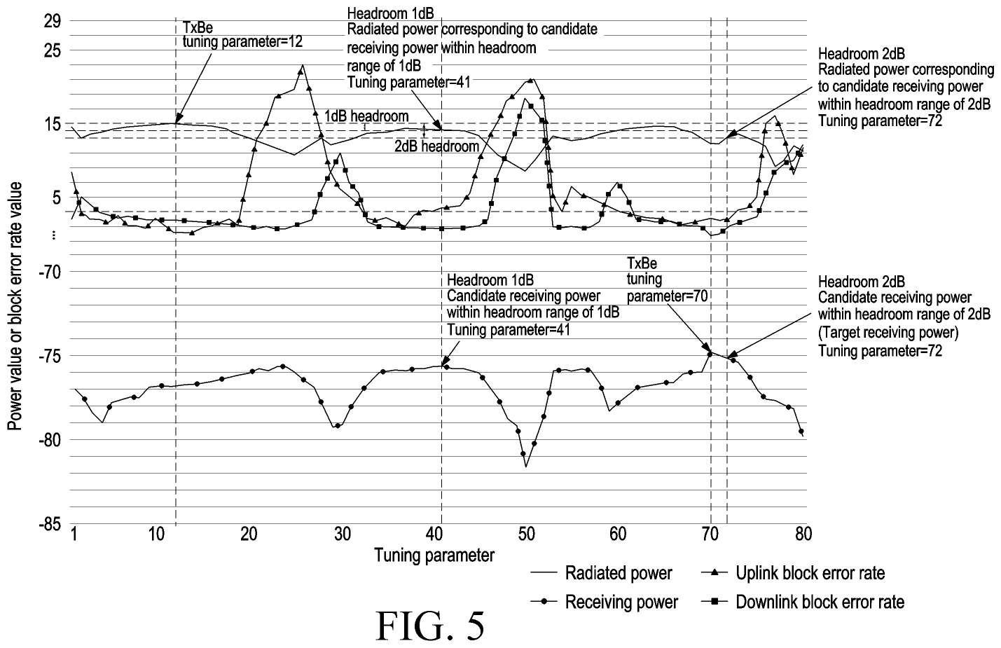

According to the example embodiment, candidate receiving powers are determined successively from among the plurality of receiving powers corresponding to the plurality of radiated powers within the headroom adjustment range based on the headroom adjustment step; a candidate receiving power meeting a preset condition is determined as the target receiving power. The determination of the target receiving power is exemplarily described with reference to FIG. 5 now.

FIG. 5 is a diagram illustrating an example of determining a target receiving power according to an example embodiment. In FIG. 5, it is assumed that the current service type is an uplink sensitive service, and it is assumed that the headroom adjustment step is 1 dB.

Referring to FIG. 5, a horizontal axis of the graph represents the tuning parameter and a vertical axis of the graph represents the power value or the block error rate (BLER) value. For example, for the radiated power, the vertical axis of the graph represents the power value in dB, and for the block error rate, the vertical axis of the graph represents a value of the block error rate in percentage.

According to the example embodiment, the determining successively candidate receiving powers from among a plurality of receiving powers corresponding to a plurality of radiated powers within the headroom adjustment range based on the headroom adjustment step may include: in the t-th determination processing (t being a positive integer less than or equal to a value of n as described above), determining the maximum and/or high receiving power among the plurality of receiving powers corresponding to the plurality of radiated powers within a headroom adjustment range in the t-th determination processing, as the candidate received power.

Specifically, according to the embodiment, in the first determination (or headroom adjustment) processing, the maximum and/or high receiving power among the plurality of receiving powers, which are corresponding to TxBe and the plurality of radiated powers within the headroom adjustment range defined by the first headroom adjustment step, is determined as the candidate receiving power. For example, referring to FIG. 5, the headroom adjustment range defined by “1 dB headroom” may represent a range of radiated powers meeting the headroom condition in the first determination processing, and a candidate receiving power with a tuning parameter of 41 may be determined by searching for the maximum receiving power among the receiving powers corresponding to the radiated powers within this range.

Specifically, according to the embodiment, in the second determination (or headroom adjustment) processing, the maximum receiving power among the plurality of receiving powers corresponding to the plurality of radiated powers within the headroom adjustment range defined by the second headroom adjustment step is determined as the candidate receiving power. For example, referring to FIG. 5, in the first determination (or headroom adjustment) processing, the headroom adjustment range is a range of the radiated powers from 15 to 14, and in the second determination (or headroom adjustment) processing, the headroom adjustment range is a range of the radiated powers from 14 to 13, and so forth, provided that the headroom adjustment range do not exceed the range defined by the maximum allowable headroom.

Similarly, and so forth, the candidate receiving power is determined within a headroom adjustment range defined by the t-th headroom adjustment step, the determination processing of the candidate receiving powers is stopped until a candidate receiving power meeting a preset condition is determined, or until the maximum number of times of headroom adjustments is reached.

As described above, candidate receiving powers may be determined successively, and the candidate receiving power meeting the preset condition is determined as the target receiving power. In order to ensure the stability of signal transmission of the service, the tuning parameter is also determined based on the block error rate (BLER).

According to the example embodiment, the candidate receiving powers among the plurality of receiving powers corresponding to the plurality of radiated powers within the headroom adjustment range are determined successively based on the headroom adjustment step; in each determination processing, when the receiving power of the antenna is the determined candidate receiving power, if a block error rate corresponding to the receiving power meets the preset condition, the determination processing of the candidate receiving power is stopped and the currently determined candidate receiving power is determined as the target receiving power. That is, the candidate receiving powers are determined recurrently based on the headroom condition in many times, and once a block error rate corresponding to a candidate receiving power in a certain determination processing meets the preset condition for the block error rate, it is determined that the radiated power and the receiving power in the optimum state are found.

The preset condition for the block error rate may include that an uplink block error rate and a downlink block error rate within a predetermined time period meet requirements of block error rates corresponding to the current service type when the receiving power of the antenna is the candidate receiving power.

According to the example embodiment, the requirements of block error rates may include a requirement of an uplink block error rate (UL BLER) and/or a requirement of a downlink block error rate (DL BLER), wherein the requirement of the uplink block error rate requirement may include that an uplink block error rate is less than an uplink block error rate threshold value B0, and the requirement of the downlink block error rate may include that a downlink block error rate is less than a downlink block error rate threshold value B1. For example, but not limited to, in each determination processing, the uplink block error rate and the downlink block error rate based on the determined candidate receiving power and the corresponding radiated power may be monitored, and whether the requirements of the block error rates are met may be determined.

Since different services have different requirements on uplink-downlink block error rates, according to the example embodiment, the block error rate threshold in the block error rate condition may be determined based on the service type. For example, Table 2 exemplarily shows examples of service types and block error rate thresholds.

TABLE 2

| Service type | B0 | B1 |
|---|---|---|
| Uplink sensitive service | 10% | 20% |
| Downlink sensitive service | 20% | 10% |
| Uplink-downlink both-sensitive service | 10% | 10% |

According to Table 2, when the service type is determined, the uplink block error rate threshold B0 and/or the downlink block error rate threshold B1 in the requirements of the block error rates for the current service type may be determined accordingly. Although the values of the different block error rate thresholds are shown in Table 2, the above parameters are only exemplary reference values, and the present disclosure is not limited thereto, and the value of the block error rate threshold may be adjusted according to specific implementation scenarios (e.g., for example, but not limited to, the actual channel environment.)

Referring to FIG. 5, it is assumed that both the uplink block error rate threshold B0 and the downlink block error rate threshold B1 are 3% (e.g., a dashed line with a vertical axis value of 3 in FIG. 5).

According to the example embodiment, in each determination processing, if a block error rate corresponding to the determined candidate receiving power meets the requirements of the block error rates, the determination processing of the candidate receiving power is terminated, and the determining the determined candidate receiving power as the target receiving power may include: in each determination processing, determining an uplink block error rate and a downlink block error rate within a predetermined time period when the receiving power of the antenna is the candidate receiving power; when the uplink block error rate and the downlink block error rate meet the requirements of the block error rates corresponding to the current service type, the determination processing of the candidate receiving power is terminated, and the candidate receiving power is determined as the target receiving power.

Specifically, as described above, in each determination processing, the candidate receiving power and the radiated power corresponding to the candidate receiving power may be determined, and accordingly, the uplink block error rate and the downlink block error rate within a predetermined time period (for example, but not limited to, 2 seconds) may be monitored and counted. For example, referring to FIG. 5, the candidate receiving power with the tuning parameter of 41 is determined in the first determination processing, however, the uplink block error rate corresponding to the tuning parameter of 41 is greater than 3%, that is, the preset condition is not met, and therefore, the next recurrent processing is continued (e.g., t=t+1).

Specifically, in the second recurrent determination processing, the maximum and/or high receiving power among the plurality of receiving powers corresponding to the plurality of radiated powers within the headroom adjustment range is determined as the candidate receiving power, wherein the headroom condition is that a difference between TxBe and the radiated power is greater than the headroom adjustment step and less than or equal to the headroom adjustment step*2. For example, referring to FIG. 5, a range of 1 dB in the lower half of the range indicated by “2 dB headroom” may represent a range of radiated powers meeting the headroom condition in the second recurrent determination processing, and the maximum receiving power within this range is searched and a candidate receiving power with a tuning parameter of 72 is determined. In a case where the tuning parameter is 72, both the uplink block error rate and the downlink block error rate meet the block error rate conditions, and therefore, the candidate receiving power with the tuning parameter of 72 is determined as the target receiving power and the determination processing is terminated.

Returning to FIG. 4, at step S440, the tuning parameter corresponding to the target receiving power is determined as a tuning parameter of the antenna.

The antenna tuning method according to the example embodiment may dynamically tune the antenna based on the service type and the network environment, which may maximize the transmitting performance and receiving performance of the antenna to an optimally balanced state, and avoid the loss of the transmitting performance or the receiving performance caused by using a fixed headroom for tuning. In addition, determining the optimal receiving power by using the block error rate may ensure the stability of the service in a case of ensuring the optimal performance of the antenna, thereby improving the transmission quality.

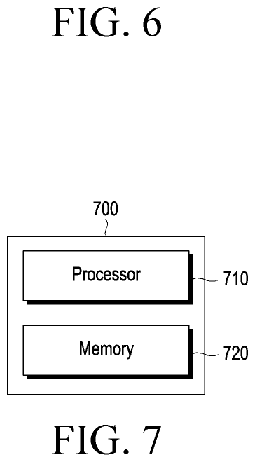

An antenna tuning device according to an example embodiment will be described below with reference to FIG. 6. FIG. 6 is a block diagram illustrating an antenna tuning device according to an example embodiment.

Referring to FIG. 6, the antenna tuning device 600 may include a radiated power determination unit 610 comprising processing circuitry, a headroom condition determination unit 620 comprising processing circuitry, a receiving power determination unit 630 comprising processing circuitry, and a tuning parameter determination unit 640 comprising processing circuitry.

According to the example embodiment, the radiated power determination unit 610 may be configured to determine a maximum radiated power of an antenna in response to detecting an abnormality of a transmitting state of the antenna. That is, the radiated power determination unit 610 may be configured to perform an operation corresponding to the above step S410, which is not described in detail herein.

According to the example embodiment, the headroom condition determination unit 620 may be configured to determine a headroom condition of the maximum radiated power for a current service type based on network parameters. That is, the headroom condition determination unit 620 may be configured to perform an operation corresponding to the above step S420, which is not described in detail herein.

According to the example embodiment, the receiving power determination unit 630 may be configured to determine a target receiving power based on the headroom condition. That is, the receiving power determination unit 630 may be configured to perform an operation corresponding to the above step S430, which is not described in detail herein.

According to the example embodiment, the tuning parameter determination unit 640 may be configured to determine a tuning parameter corresponding to the target receiving power as a tuning parameter of the antennas. That is, the tuning parameter determination unit 640 may be configured to perform an operation corresponding to the above step S440, which is not described in detail herein.

According the example embodiment, the headroom condition determination unit 620 is configured to determine the headroom condition of the maximum radiated power for the current service type based on the network parameters by: determining an uplink path loss and an expected transmitting power based on the network parameters; determining the headroom condition of the maximum radiated power for the current service type based on the uplink path loss and the expected transmitting power, wherein the headroom condition includes a headroom adjustment step and a headroom adjustment range.

According to the example embodiment, the headroom condition determination unit 620 is configured to determine the headroom condition of the maximum radiated power for the current service type based on the uplink path loss and the expected transmitting power by: determining the headroom adjustment step and an correction factor of the expected transmitting power for the current service type based on the uplink loss; determining the headroom adjustment range based on the expected transmitting power and the correction factor of the expected transmitting power. “Based on” as used herein covers based at least on.

According to the example embodiment, the receiving power determination unit 630 is configured to determine the target receiving power based on the headroom condition by: determining successively candidate receiving powers from among a plurality of receiving powers corresponding to a plurality of radiated powers within the headroom adjustment range based on the headroom adjustment step; determining a candidate receiving power meeting a preset condition as the target receiving power.

According to the example embodiment, the preset condition may include that an uplink block error rate and a downlink block error rate within a predetermined time period meet requirements of block error rates corresponding to the current service type when the receiving power of the antenna is the candidate receiving power.

According to the example embodiment, the service type may include at least one of an uplink sensitive service, a downlink sensitive service, and an uplink-downlink both-sensitive service.

Further, it should be understood that the respective unit in the antenna tuning device 600 according to the example embodiment may be implemented with a hardware component and/or software component. Those skilled in the art may, for example, but is not limited to, implementing the respective unit using a field programmable gate array (FPGA) or application-specific integrated circuit (ASIC) according the defined operation performed by the respective unit.

The specific manner of performing the operation by the respective unit of the antenna tuning device 600 has been described in detail in the embodiments of the related method with reference to FIG. 4, and it will not be described in detail here.

FIG. 7 is a block diagram illustrating an electronic apparatus according to an example embodiment.

Referring to FIG. 7, the electronic apparatus (or device) 700 may include at least one processor 710 and at least one memory 720 storing computer executable instructions. According to the example embodiment, the computer executable instructions, when being executed by the at least one processor 710, cause the electronic apparatus 700 (or the at least one processor 710) to perform the antenna tuning method as described above.

As an example, the electronic apparatus 700 may be a PC computer, a tablet device, a personal digital assistant, a smartphone, or other devices capable of executing a set of instructions described above. Here, the electronic apparatus 700 does not have to be a single electronic apparatus, but may also be any collection of apparatuses or circuits capable of executing individually or jointly the above-described instructions (or the set of instructions). The electronic apparatus 700 may also be a part of an integrated control system or system manager, or may be configured as a portable electronic apparatus that is interfaced with local or remote (e.g., but not limited to, via wireless transmission).

In the electronic apparatus 700, the at least one processor 710 may include a central processing unit (CPU), a graphics processing unit (GPU), a programmable logic device, a specialized processor system, a microcontroller, or a microprocessor. According to the example embodiment, the at least one processor 710 may also include an analog processor, a digital processor, a microprocessor, a multicore processor, a processor array, a network processor, and the like.

The at least one processor 710 may execute instructions or codes stored in the at least one memory 720, wherein the at least one memory 720 may also store data. The instructions and data may also be transmitted and received through a network via a network interface device, wherein network interface device may adopt any known transmission protocol.

The at least one memory 720 may be integrated with the at least one processor 710, for example, but not limited to, by placing a RAM or flash memory within an integrated circuit microprocessor, etc. In addition, the least one memory 720 may include an independent device, such as, an external disk driver, a storage array, or other storage devices that may be used by any database system. The least one memory 720 and the at least one processor 710 may be directly or indirectly coupled operationally, or they may for example, but not limited to, communicate with each other through an I/O port, a network connection, etc., so that the at least one processor 710 is capable of reading a file stored in the at least one memory 720.

According to an example embodiment, a computer-readable storage medium storing instructions is also provided. The instructions in the computer-readable storage medium, when being executed by at least one processor, cause the at least one processor to perform the antenna tuning method as described above.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Each embodiment herein may be used in combination with any other embodiment(s) described herein.

According to the example embodiment, the computer-readable storage medium may include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state hard disk (SSD), card memory (such as a multimedia card, secure digital (SD) card, or extreme digital (XD) card), magnetic tape, floppy disk, magneto-optical data storage device, optical data storage device, hard disk, solid state disk, and any other devices configured to store the instructions, computer programs and any associated data, data files and data structures in a non-transitory manner, and provide the instructions, the computer programs and any associated data, data files and data structures to a processor or computer so that the processor or computer may execute the instructions, the computer programs.

The instructions, the computer programs and any associated data, data files and data structures in the above-mentioned computer-readable storage medium may be executed in an environment deployed in an electronic apparatus such as a client, a host, a proxy apparatus, a server, etc. in addition, in one example, the instructions, the computer programs and any associated data, data files and data structures are distributed over networked computer systems so that the instructions, the computer programs and any associated data, data files and data structures are stored in a distributed manner, accessed and executed by one or more processors or computers.

The present application intends to cover any variation, use or adaptation of the present disclosure, which follow general principles of the present disclosure and include the common general knowledge or commonly-used technical means in the technical field, which are not disclosed in the present disclosure. The description and the embodiments are only regarded as exemplary, and the true scope and spirit of the present disclosure are indicated by the claims. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

It should be understood that the present disclosure is not limited to the precise structure described above and shown in the drawings, and various modifications and changes may be made without departing from scope thereof. The scope of the present disclosure is limited only by the claims.

What is claimed is:

1. A method for tuning an antenna by an electronic device, the method comprising:
determining a maximum radiated power of an antenna of the electronic device based on detecting an abnormality of a transmitting state of the antenna;
determining a headroom condition of the maximum radiated power for a current service type based on network parameters;
determining a target receiving power based on the headroom condition; and
determining a tuning parameter of the antenna based on the target receiving power.

2. The method of claim 1, wherein determining the headroom condition of the maximum radiated power for the current service type based on the network parameters comprises:
determining an uplink path loss and an expected transmitting power based on the network parameters; and
determining the headroom condition of the maximum radiated power for the current service type based on the uplink path loss and the expected transmitting power, wherein the headroom condition comprises a headroom adjustment step and a headroom adjustment range.

3. The method of claim 2, wherein determining the headroom condition of the maximum radiated power for the current service type based on the uplink path loss and the expected transmitting power comprises:
determining the headroom adjustment step and a correction factor of the expected transmitting power for the current service type based on the uplink path loss; and
determining the headroom adjustment range based on the expected transmitting power and the correction factor of the expected transmitting power.

4. The method of claim 2, wherein determining the target receiving power based on the headroom condition comprises:
determining successively candidate receiving powers from among a plurality of receiving powers corresponding to a plurality of radiated powers within the headroom adjustment range based on the headroom adjustment step; and
determining a candidate receiving power meeting a preset condition as the target receiving power.

5. The method of claim 4, wherein the preset condition comprises that an uplink block error rate and a downlink block error rate within a predetermined time period meet requirements of block error rates corresponding to the current service type when the receiving power of the antenna is the candidate receiving power.

6. The method of claim 1, wherein the service type comprises at least one of an uplink sensitive service, a downlink sensitive service, or an uplink-downlink both-sensitive service.

7. The method of claim 1, further comprising:
tuning the antenna based on the determined tuning parameter of the antenna.

8. An electronic device for tuning an antenna, the electronic device comprising:
memory storing instructions; and
at least one processor coupled to the memory, wherein the instructions, which when executed by the at least one processor, cause the electronic device to perform operations comprising:
determining a maximum radiated power of an antenna of the electronic device based on detecting an abnormality of a transmitting state of the antenna;
determining a headroom condition of the maximum radiated power for a current service type based on network parameters;
determining a target receiving power based on the headroom condition; and
determining a tuning parameter of the antenna based on the target receiving power.

9. The electronic device of claim 8, wherein determining the headroom condition of the maximum and/or high radiated power for the current service type based on the network parameters comprises:
determining an uplink path loss and an expected transmitting power based on the network parameters; and
determining the headroom condition of the maximum and/or high radiated power for the current service type based on the uplink path loss and the expected transmitting power, wherein the headroom condition comprises a headroom adjustment step and a headroom adjustment range.

10. The electronic device of claim 9, wherein determining the headroom condition of the maximum and/or high radiated power for the current service type based on the uplink path loss and the expected transmitting power comprises:
determining the headroom adjustment step and a correction factor of the expected transmitting power for the current service type based on the uplink path loss; and
determining the headroom adjustment range based on the expected transmitting power and the correction factor of the expected transmitting power.

11. The electronic device of claim 9, wherein determining the target receiving power based on the headroom condition comprises:
determining successively candidate receiving powers from among a plurality of receiving powers corresponding to a plurality of radiated powers within the headroom adjustment range based on the headroom adjustment step; and
determining a candidate receiving power meeting a preset condition as the target receiving power.

12. The electronic device of claim 11, wherein the preset condition comprises that an uplink block error rate and a downlink block error rate within a predetermined time period meet requirements of block error rates corresponding to the current service type when the receiving power of the antenna is the candidate receiving power.

13. The electronic device of claim 8, wherein the service type comprises at least one of an uplink sensitive service, a downlink sensitive service, or an uplink-downlink both-sensitive service.

14. The electronic device of claim 8, wherein the operations further comprise:
tuning the antenna based on the determined tuning parameter of the antenna.

15. A non-transitory computer-readable storage medium storing instructions which, when executed by at least one processor of an electronic device, cause the electronic device to perform operations comprising:
determining a maximum radiated power of an antenna of the electronic device based on detecting an abnormality of a transmitting state of the antenna;
determining a headroom condition of the maximum radiated power for a current service type based on network parameters;
determining a target receiving power based on the headroom condition; and
determining a tuning parameter of the antenna based on the target receiving power.

16. The non-transitory computer-readable storage medium of claim 15, wherein determining the headroom condition of the maximum radiated power for the current service type based on the network parameters comprises:
determining an uplink path loss and an expected transmitting power based on the network parameters; and
determining the headroom condition of the maximum radiated power for the current service type based on the uplink path loss and the expected transmitting power, wherein the headroom condition comprises a headroom adjustment step and a headroom adjustment range.

17. The non-transitory computer-readable storage medium of claim 16, wherein determining the headroom condition of the maximum radiated power for the current service type based on the uplink path loss and the expected transmitting power comprises:
determining the headroom adjustment step and a correction factor of the expected transmitting power for the current service type based on the uplink path loss; and
determining the headroom adjustment range based on the expected transmitting power and the correction factor of the expected transmitting power.

18. The non-transitory computer-readable storage medium of claim 16, wherein determining the target receiving power based on the headroom condition comprises:
determining successively candidate receiving powers from among a plurality of receiving powers corresponding to a plurality of radiated powers within the headroom adjustment range based on the headroom adjustment step; and
determining a candidate receiving power meeting a preset condition as the target receiving power.

19. The non-transitory computer-readable storage medium of claim 18, wherein the preset condition comprises that an uplink block error rate and a downlink block error rate within a predetermined time period meet requirements of block error rates corresponding to the current service type when the receiving power of the antenna is the candidate receiving power.

20. The non-transitory computer-readable storage medium of claim 15, wherein the service type comprises at least one of an uplink sensitive service, a downlink sensitive service, or an uplink-downlink both-sensitive service.
